(19) United States
(12) Patent Application Publication
(10) Pub. No.: US 2026/0081293 A1
(43) Pub. Date: Mar. 19, 2026

(54) SECONDARY BATTERY AND BATTERY PACK INCLUDING THE SAME

(71) Applicant: SAMSUNG SDI CO., LTD., Yongin-si (KR)

(72) Inventors: Dae Kyu KIM, Suwon-si (KR); Min Jae KIM, Suwon-si (KR); Shin Jung KIM, Suwon-si (KR)

(21) Appl. No.: 19/294,027

(22) Filed: Aug. 7, 2025

(30) Foreign Application Priority Data
Sep. 13, 2024 (KR) 10-2024-0125792

(51) Int. Cl. H01M 50/30; H01M 10/0525; H01M 50/107; H01M 50/152; H01M 50/213

(52) U.S. Cl. CPC H01M 50/30; H01M 10/0525; H01M 50/107; H01M 50/152; H01M 50/213

(57) ABSTRACT

A secondary battery and a battery pack are disclosed. A secondary battery includes a case including an opening, an electrode assembly in the case, a cap up arranged in the opening, a cap down facing the cap up and connected to the electrode assembly, a vent plate between the cap up and the cap down and including a first vent surface and a second vent surface that are opposite to each other, a first notch formed concavely from the first vent surface toward the second vent surface, and a second notch formed concavely from the second vent surface toward the first vent surface.

### CROSS-REFERENCE TO RELATED APPLICATION

The present application claims priority to and the benefit of Korean Patent Application No. 10-2024-0125792, filed on Sep. 13, 2024 in the Korean Intellectual Property Office, the entire disclosure of which is incorporated herein by reference.

### BACKGROUND

### 1. Field

Aspects of embodiments of the present disclosure relate to a secondary battery and a battery pack including the same.

### 2. Description of the Related Art

In general, due to the recent proliferation of electronic devices using batteries, such as mobile phones, notebook computers, and electric vehicles, the demand for secondary batteries having high energy density and high capacity has rapidly increased. Accordingly, research and development for improving the performance of a lithium secondary battery are being actively conducted.

A lithium secondary battery is a battery including a positive electrode and a negative electrode including an active material capable of intercalating and deintercalating lithium ions, and an electrolyte solution, and generates energy through oxidation/reduction reactions when lithium ions are intercalated/deintercalated at the positive and negative electrodes.

The above-described information disclosed in the technology that forms the background of the present disclosure is provided to improve understanding of the background of the present disclosure, and thus may include information that does not constitute the related art.

### SUMMARY

According to an aspect of embodiments of the present disclosure, a secondary battery and a battery pack capable of reducing a deformation amount of a vent plate when an internal pressure of a case increases are provided.

The above and other aspects and features of the present disclosure will be described in or will be apparent from the following description of some embodiments of the present disclosure.

According to one or more embodiments of the present disclosure, a secondary battery includes: a case including an opening; an electrode assembly in the case; a cap up arranged in the opening; a cap down facing the cap up and connected to the electrode assembly; a vent plate between the cap up and the cap down and including a first vent surface and a second vent surface that are opposite to each other; a first notch formed concavely from the first vent surface toward the second vent surface; and a second notch formed concavely from the second vent surface toward the first vent surface.

The first vent surface may face the cap up, and the second vent surface may face the cap down.

The first notch and the second notch may face each other.

The second notch may be forged.

At least a portion of a width of the second notch may be greater than a width of the first notch.

A depth of the second notch may be greater than a depth of the first notch.

A width of the first notch may decrease toward the second vent surface.

A cross-sectional shape of the first notch may be a trapezoidal shape.

A cross-sectional shape of the first notch may be a triangular shape.

A width of the second notch may decrease toward the first vent surface.

A cross-sectional shape of the second notch may be a trapezoidal shape.

A cross-sectional shape of the second notch may be a triangular shape.

The vent plate may include a bridge between the first notch and the second notch.

A thickness of the bridge may be greater than or equal to 0.04 mm and less than or equal to 0.1 mm.

The secondary battery may further include an extending notch connected to the second notch and formed concavely toward the first vent surface.

A width of the extending notch may be smaller than a width of the second notch.

The secondary battery may further include a third notch formed concavely from the first vent surface toward the second vent surface and spaced apart from the first notch.

The first notch and the second notch may face each other, and the third notch and the second notch may be misaligned with each other.

A depth of the third notch may be greater than a depth of the first notch.

According to one or more embodiments of the present disclosure, a battery pack includes: a housing; and a plurality of secondary batteries accommodated in the housing, wherein each of the secondary batteries includes: a case including an opening; an electrode assembly in the case; a cap up arranged in the opening; a cap down facing the cap up and connected to the electrode assembly; a vent plate between the cap up and the cap down and including a first vent surface and a second vent surface that are opposite to each other; a first notch formed concavely from the first vent surface toward the second vent surface; and a second notch formed concavely from the second vent surface toward the first vent surface.

### BRIEF DESCRIPTION OF THE DRAWINGS

The drawings attached to this specification illustrate some embodiments of the present disclosure, and further describe aspects and features of the present disclosure together with the detailed description of the present disclosure. However, the present disclosure us not to be construed as being limited to the drawings.

FIG. 1 is a perspective view schematically illustrating a configuration of a secondary battery according to an embodiment of the present disclosure;

FIG. 2 is a cross-sectional view schematically illustrating the configuration of the secondary battery of FIG. 1;

FIG. 3 is a view schematically illustrating a configuration of a cap assembly according to an embodiment of the present disclosure;

FIG. 4 is an enlarged view of a half region of the cap assembly of FIG. 3;

FIG. 5 is a view schematically illustrating configurations of a first notch and a second notch according to an embodiment of the present disclosure;

FIG. 6 is a view schematically illustrating a deformation operation of a vent plate according to an embodiment of the present disclosure;

FIG. 7 is a view schematically illustrating configurations of a first notch and a second notch according to another embodiment of the present disclosure;

FIG. 8 is a view schematically illustrating configurations of a first notch and a second notch according to another embodiment of the present disclosure;

FIG. 9 is a view schematically illustrating configurations of a first notch and a second notch according to another embodiment of the present disclosure;

FIG. 10 is a view schematically illustrating a configuration of an extending notch according to another embodiment of the present disclosure;

FIG. 11 is a view schematically illustrating a configuration of a secondary battery according to another embodiment of the present disclosure;

FIG. 12 is a view schematically illustrating a configuration of a third notch according to an embodiment of the present disclosure; and

FIG. 13 is a perspective view schematically illustrating a configuration of a battery pack according to an embodiment of the present disclosure.

### DETAILED DESCRIPTION

Herein, some embodiments of the present disclosure will be described, in further detail, with reference to the accompanying drawings. The terms or words used in this specification and claims are not to be construed as being limited to the usual or dictionary meaning and should be interpreted as meaning and concept consistent with the technical idea of the present disclosure based on the principle that the inventor can be his/her own lexicographer to appropriately define the concept of the term.

The embodiments described in this specification and the configurations shown in the drawings are provided as some example embodiments of the present disclosure and do not necessarily represent all of the technical ideas, aspects, and features of the present disclosure. Accordingly, it is to be understood that there may be various equivalents and modifications that may replace or modify the embodiments described herein at the time of filing this application.

It is to be understood that when an element or layer is referred to as being “on,” “connected to,” or “coupled to” another element or layer, it may be directly on, connected, or coupled to the other element or layer, or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element, or the first element may be indirectly coupled or connected to the second element via one or more intervening elements.

In the figures, dimensions of the various elements, layers, etc. may be exaggerated for clarity of illustration. The same reference numerals designate the same or like elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B, and C,” “at least one of A, B, or C,” “at least one selected from a group of A, B, and C,” or “at least one selected from among A, B, and C” are used to designate a list of elements A, B, and C, the phrase may refer to any and all suitable combinations or a subset of A, B, and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It is to be understood that, although the terms “first,” “second,” “third,” etc. may be used herein to describe various elements, components, regions, layers, and/or sections, these elements, components, regions, layers, and/or sections are not to be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It is to be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (e.g., rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It is to be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all sub-ranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

References to two compared elements, features, etc. as being “the same” may mean that they are the same or substantially the same. Thus, the phrase “the same” or “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an arbitrary element is referred to as being arranged (or located or positioned) on the “above (or below)” or “on (or under)” a component, it may mean that the arbitrary element is placed in contact with the upper (or lower) surface of the component and may also mean that another component may be interposed between the component and any arbitrary element arranged (or located or positioned) on (or under) the component.

In addition, it is to be understood that when an element is referred to as being “coupled,” “linked,” or “connected” to another element, the elements may be directly “coupled,” “linked,” or “connected” to each other, or one or more intervening elements may be present therebetween, through which the element may be “coupled,” “linked,” or “connected” to another element. In addition, when a part is referred to as being “electrically coupled” to another part, the part may be directly electrically connected to another part, or one or more intervening parts may be present therebetween such that the part and the another part are indirectly electrically connected to each other.

Throughout the specification, when “A and/or B” is stated, it means A, B, or A and B, unless otherwise stated. That is, “and/or” includes any or all combinations of a plurality of items enumerated. When “C to D” is stated, it means C or more and D or less, unless otherwise specified.

The terms used in the present specification are for describing embodiments of the present disclosure and are not intended to limit the present disclosure.

The terms used herein are intended to describe embodiments of the present disclosure and are not intended to be limiting.

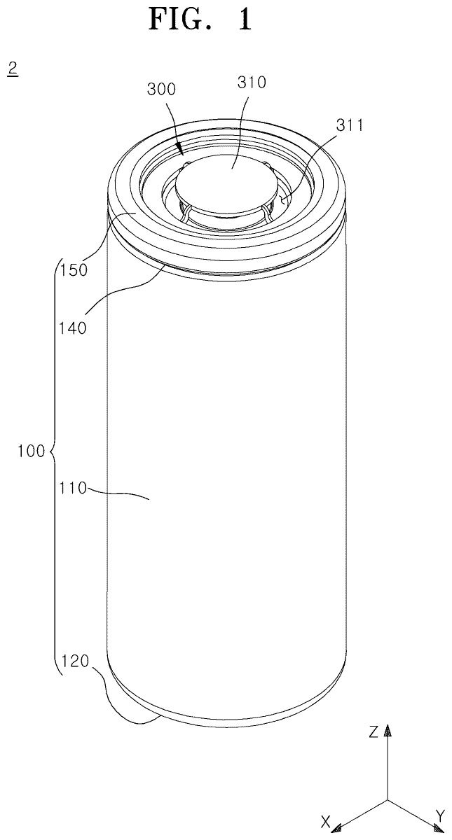

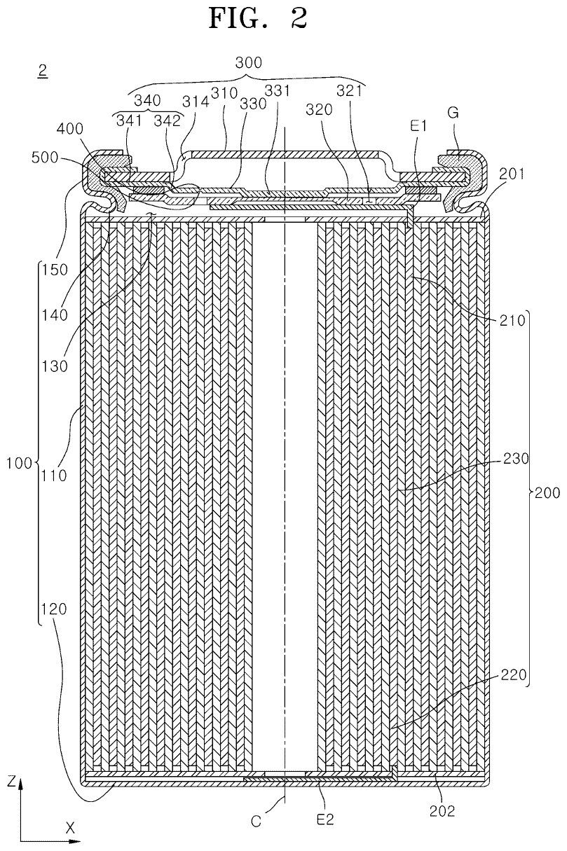

FIG. 1 is a perspective view schematically illustrating a configuration of a secondary battery according to an embodiment of the present disclosure; and FIG. 2 is a cross-sectional view schematically illustrating the configuration of the secondary battery of FIG. 1.

Referring to FIGS. 1 and 2, a secondary battery 2 according to an embodiment may include a case 100, an electrode assembly 200, a cap assembly 300, a first notch 400, and a second notch 500.

Herein, an example in which the secondary battery 2 is a cylindrical battery as a lithium-ion secondary battery will be described. However, the present disclosure is not limited thereto, and the secondary battery 2 may be a lithium polymer battery or a prismatic battery, for example.

The case 100 may generally form an exterior of the secondary battery 2. In an embodiment, the case 100 may be provided to be electrically conductive. For example, the case 100 may include a material of at least one of steel, stainless steel, aluminum, and an aluminum alloy. Accordingly, the case 100 may protect the electrode assembly 200 from an external impact and perform a heat dissipation function of dissipating heat accompanying the charging and discharging operations of the electrode assembly 200 to the outside.

The case 100 according to an embodiment may include a side wall portion 110 having a cylindrical shape. A central axis C of the case 100 may be a central axis of the side wall portion 110 of the case 100 to be described below. In an embodiment, both, or opposite, end portions of the side wall portion 110 perpendicular to the central axis C of the case 100 may be formed to be open.

The case 100 may further include a bottom portion 120 which closes a lower end portion of the side wall portion 110. The bottom portion 120 according to an embodiment may be formed to have a generally circular plate shape, and may be disposed to face the lower end portion of the side wall portion 110. The bottom portion 120 may be disposed perpendicular to the central axis C of the case 100. A circumference of the bottom portion 120 may be joined to the lower end portion of the side wall portion 110. In an embodiment, the bottom portion 120 may be molded integrally with the side wall portion 110 by a drawing process or the like, or may be joined to the side wall portion 110 by welding or the like after being manufactured separately from the side wall portion 110.

The case 100 may further include an opening 130 which opens an upper end portion of the side wall portion 110. The opening 130 may provide a path through which the electrode assembly 200 to be described below is inserted into the case 100 at an upper end region of the case 100, and provide a space where the cap assembly 300 to be described below may be installed. The opening 130 according to an embodiment may be an empty space surrounded by the upper end region of the side wall portion 110 located at an opposite side of the bottom portion 120.

The case 100 according to an embodiment may further include a beading portion 140.

The beading portion 140 may protrude into the case 100. The beading portion 140 may restrict the cap assembly 300 to be described below from being inserted into the case 100 beyond a certain or set distance, and may prevent or substantially prevent the electrode assembly 200 from being separated from the case 100.

The beading portion 140 according to an embodiment may be disposed on the upper end portion of the side wall portion 110. A central portion of the beading portion 140 may be formed concavely toward a central axis C of the case 100. In an embodiment, the beading portion 140 may be integrally formed with the side wall portion 110, or may be coupled to the side wall portion 110 after being manufactured separately from the side wall portion 110.

Herein, an example in which the secondary battery 2 according to an embodiment includes the beading portion 140 will be described, but the present disclosure is not limited thereto, and the secondary battery 2 may be configured in a form in which the beading portion 140 is omitted.

An electrolyte may be filled in the case 100. The electrolyte may be injected into the case 100 through the opening 130 of the case 100.

The electrode assembly 200 may be a unit structure which performs charging and discharging operations of power in the secondary battery 2. The electrode assembly 200 may include a first electrode 210, a second electrode 220, and a separator 230 disposed between the first electrode 210 and the second electrode 220.

The electrode assembly 200 may be disposed in the case 100. The electrode assembly 200 may be inserted into the case 100 through the opening 130 of the case 100.

In an embodiment, the electrode assembly 200 may have a cylindrical shape formed with a winding hole in a central portion. In an embodiment, the electrode assembly 200 may be wound clockwise or counterclockwise around the winding hole in a state in which the first electrode 210, the separator 230, and the second electrode 220 are stacked. Accordingly, the electrode assembly 200 may have a generally jellyroll shape. The central axis of the winding hole may be disposed coaxially with the central axis C of the case 100. A cross-sectional shape of the electrode assembly 200 may be designed to have any of various shapes, such as an oval shape, a polygonal shape, and the like, in addition to a circular shape.

The first electrode 210, the separator 230, and the second electrode 220 may be disposed sequentially in a concentric circle along a radial direction of the electrode assembly 200 from the winding hole. Both, or opposite, end portions of each of the first electrode 210, the second electrode 220, and the separator 230 which are parallel to the central axis C of the case 100 may be disposed to respectively face the bottom portion 120 and the opening 130 of the case 100.

The first electrode 210 may function as a positive electrode of the electrode assembly 200. The first electrode 210 may be formed to have a foil form including a metal material, such as aluminum or an aluminum alloy. A type, size, shape, or the like of the first electrode 210 is not particularly limited as long it has conductivity and does not cause a chemical change in the secondary battery 2.

The first electrode 210 may be electrically connected to the cap assembly 300 to be described below. In an embodiment, the first electrode 210 functions as the positive electrode of the electrode assembly 200, and the cap assembly 300 may function as a positive electrode terminal of the secondary battery 2. For example, the first electrode 210 may be electrically connected to the cap assembly 300 by a first electrode tab E1.

The first electrode tab E1 according to an embodiment may include a conductive metal material, such as copper, a copper alloy, nickel, or a nickel alloy. The first electrode tab E1 may be disposed at an upper side of the electrode assembly 200, and both, or opposite, end portions of the first electrode tab E1 may be respectively connected to the first electrode 210 and the cap assembly 300. An end portion of the first electrode tab E1 may be directly connected to the first electrode 210, or may be indirectly connected to the first electrode 210 through a separate current collector plate (not shown) connected to the first electrode 210.

A first active material layer may be applied on at least a portion of the first electrode 210. The first active material layer may be applied on both, or opposite, surfaces of the first electrode 210, or may be applied on only one surface of the first electrode 210.

In an embodiment, the first electrode 210 functions as a positive electrode, and the first active material layer may include a positive electrode active material.

The positive electrode active material may be a compound capable of reversible intercalating and deintercalating of lithium (a lithiated intercalation compound). In an embodiment, one or more types of a composite oxide of lithium and a metal selected from cobalt, manganese, nickel, iron, and a combination thereof may be used.

For example, the positive electrode active material may include at least one of lithium-iron-phosphorus oxide (LiFePO₄, LFP), lithium-manganese-iron-phosphorus oxide (LiMnFePO₄, LMFP), and lithium-nickel-cobalt-manganese oxide (LiNiₓCo_{y}Mn_{z}O₂, NCM). Here, 0<x<1, 0<y<1, 0<z<1, x+y+z=1 may be satisfied. The positive electrode active material may include only one of lithium-iron-phosphorus oxide (LiFePO₄, LFP), lithium-manganese-iron-phosphorus oxide (LiMnFePO₄, LMFP), and lithium-nickel-cobalt-manganese oxide (LiNiₓCo_{y}Mn_{z}O₂, LNCM), and may also include two or all of lithium-iron-phosphorus oxide (LiFePO₄, LFP), lithium-manganese-iron-phosphorus oxide (LiMnFePO₄, LMFP), and lithium-nickel-cobalt-manganese oxide (LiNiₓCo_{y}Mn_{z}O₂, NCM).

The first active material layer may further include a positive electrode conductive material.

The positive electrode conductive material imparts conductivity to the first active material layer, and any suitable material which does not cause a chemical change and is electronically conductive may be used. Examples of the positive electrode conductive material may include a carbon-based material, such as natural graphite, artificial graphite, carbon black, acetylene black, Ketjen black, carbon fibers, carbon nanofibers, carbon nanotubes, or the like, a metal-based material in the form of metal powder or metal fibers containing copper, nickel, aluminum, silver, or the like, a conductive polymer, such as a polyphenylene derivative or the like, or a mixture thereof.

The first active material layer may further include a positive electrode binder.

The positive electrode binder attaches the particles constituting the positive electrode active material to each other well, and also attaches the positive electrode active material to the first electrode 210 well.

Examples of the positive electrode binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be selected from styrene-butadiene rubber, (meth)acrylated styrene-butadiene rubber, (meth)acrylonitrile-butadiene rubber, (meth)acrylic rubber, butyl rubber, a fluoroelastomer, polyethylene oxide, polyvinylpyrrolidone, polyepichlorohydrin, polyphosphazene, poly(meth)acrylonitrile, an ethylene propylene diene copolymer, polyvinyl pyridine, chlorosulfonated polyethylene, latex, a polyester resin, a (meth)acrylic resin, a phenol resin, an epoxy resin, polyvinyl alcohol, and a combination thereof.

If the aqueous binder is used as the positive electrode binder, a cellulose-based compound capable of imparting viscosity may be further included. As the cellulose-based compound, one or more types of carboxymethyl cellulose, hydroxypropylmethyl cellulose, methyl cellulose, or alkali metal salts thereof may be used in combination. In an embodiment, Na, K, or Li may be used as the alkali metal.

The dry binder is a polymer material which may be fiberized and may be, for example, polytetrafluoroethylene, polyvinylidene fluoride, a polyvinylidene fluoride-hexafluoropropylene copolymer, polyethylene oxide, or a combination thereof.

The second electrode 220 may function as a negative electrode of the electrode assembly 200. The second electrode 220 may be formed to have a foil shape including a metal material, such as copper, a copper alloy, nickel, or a nickel alloy. The second electrode 220 may be disposed to be spaced apart from the first electrode 210 by an interval (e.g., a certain interval) and face the first electrode 210.

The second electrode 220 may be electrically connected to the case 100. For example, the second electrode 220 may be electrically connected to the case 100 by a second electrode tab E2. In an embodiment, the second electrode 220 functions as the negative electrode of the electrode assembly 200, and the case 100 may function as a negative electrode terminal of the secondary battery 2. The second electrode tab E2 according to an embodiment may include a conductive metal material, such as copper, a copper alloy, nickel, or a nickel alloy. The second electrode tab E2 may be disposed at a lower side of the electrode assembly 200, and both, or opposite, end portions of the second electrode tab E2 may be respectively connected to the second electrode 220 and the bottom portion 120 of the case 100. An end portion of the second electrode tab E2 may be directly connected to the second electrode 220, or may be indirectly connected to the second electrode 220 through a separate current collector plate (not shown) connected to the second electrode 220.

A type, size, shape or the like of the second electrode 220 is not particularly limited as long it has conductivity and does not cause a chemical change in the secondary battery 2.

A second active material layer may be applied on at least a portion of the second electrode 220. The second active material layer may be applied on both, or opposite, surfaces of the second electrode 220, or may be applied on only one surface of the second electrode 220.

In an embodiment, the second electrode 220 functions as a negative electrode, and the second active material layer may include a negative electrode active material.

The negative electrode active material may include a material capable of reversibly intercalating and deintercalating lithium ions, lithium metal, an alloy of lithium and a metal, a material capable of doping and dedoping lithium, or a transition metal oxide.

The material capable of reversibly intercalating and deintercalating lithium ions may include a carbon-based negative electrode active material, for example, crystalline carbon, amorphous carbon, or a combination thereof. An example of crystalline carbon may be graphite, such as amorphous, plate-shaped, flaky, spherical, or fibrous natural graphite or artificial graphite, and an example of amorphous carbon may be soft carbon or hard carbon, mesophase pitch carbide, calcined coke, or the like.

An alloy of lithium and a metal selected from Na, K, Rb, Cs, Fr, Be, Mg, Ca, Sr, Si, Sb, Pb, In, Zn, Ba, Ra, Ge, Al, and Sn may be used as the alloy of lithium and a metal.

An Si-based negative electrode active material or Sn-based negative electrode active material may be used as the material capable of doping and dedoping lithium. The Si-based negative electrode active material may be silicon, a silicon-carbon composite, SiOₓ (x is 1 or 2), an Si-Q alloy (Q is selected from an alkali metal, an alkaline earth metal, a Group 13 element, a Group 14 element (excluding Si), a Group 15 element, a Group 16 element, a transition metal, a rare earth element, and a combination thereof), or a combination thereof. The Sn-based negative electrode active material may be Sn, SiOₓ (x is 1 or 2, e.g., SnO₂), an Sn-based alloy, or a combination thereof.

The silicon-carbon composite may be a composite of silicon and amorphous carbon. The silicon-carbon composite may be in the form of silicon particles whose surfaces are coated with amorphous carbon. For example, the silicon-carbon composite may include a secondary particle (a core) in which silicon primary particles are assembled, and an amorphous carbon coating layer (a shell) located on the surface of the secondary particle. The amorphous carbon may be located between the silicon primary particles, and, for example, the silicon primary particles may be coated with amorphous carbon. The secondary particles may be dispersed in an amorphous carbon matrix.

The silicon-carbon composite may further include crystalline carbon. For example, the silicon-carbon composite may include a core containing crystalline carbon and silicon particles, and an amorphous carbon coating layer located on the surface of the core.

The Si-based negative electrode active material or the Sn-based negative electrode active material may be used in combination with the carbon-based negative electrode active material.

The second active material layer may further include a negative electrode conductive material and a negative electrode binder.

The negative electrode conductive material imparts conductivity to the second active material layer, and any suitable material which does not cause a chemical change and is electronically conductive may be used. Examples of the negative electrode conductive material may include a carbon-based material, such as natural graphite, artificial graphite, carbon black, acetylene black, Ketjen black, carbon fibers, carbon nanofibers, carbon nanotubes, or the like, a metal-based material in the form of metal powder or metal fibers containing copper, nickel, aluminum, silver, or the like, a conductive polymer, such as a polyphenylene derivative or the like, or a mixture thereof.

The negative electrode binder attaches the particles constituting the negative electrode active material to each other well, and also attaches the negative electrode active material to the second electrode 220 well.

Examples of the negative electrode binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be selected from styrene-butadiene rubber, (meth)acrylated styrene-butadiene rubber, (meth)acrylonitrile-butadiene rubber, (meth)acrylic rubber, butyl rubber, a fluoroelastomer, polyethylene oxide, polyvinylpyrrolidone, polyepichlorohydrin, polyphosphazene, poly(meth)acrylonitrile, an ethylene propylene diene copolymer, polyvinyl pyridine, chlorosulfonated polyethylene, latex, a polyester resin, a (meth)acrylic resin, a phenol resin, an epoxy resin, polyvinyl alcohol, and a combination thereof.

If the aqueous binder is used as the negative electrode binder, a cellulose-based compound capable of imparting viscosity may be further included. The cellulose-based compound may be used in combination with one or more types of carboxymethyl cellulose, hydroxypropylmethyl cellulose, methyl cellulose, and alkali metal salts thereof. In an embodiment, Na, K, or Li may be used as the alkali metal.

The dry binder is a polymer material which may be fiberized and may be, for example, polytetrafluoroethylene, polyvinylidene fluoride, a polyvinylidene fluoride-hexafluoropropylene copolymer, polyethylene oxide, or a combination thereof.

The separator 230 may be disposed between the first electrode 210 and the second electrode 220. The separator 230 may prevent or substantially prevent a short circuit between the first electrode 210 and the second electrode 220 while allowing lithium ions to move between the first electrode 210 and the second electrode 220.

As the separator 230, polyethylene, polypropylene, polyvinylidene fluoride, or a multilayer film of two or more layers thereof may be used, and a mixed multilayer film such as a polyethylene/polypropylene two-layer separator, a polyethylene/polypropylene/polyethylene three-layer separator, a polypropylene/polyethylene/polypropylene three-layer separator, or the like may be used.

The separator 230 may include a porous substrate and a coating layer containing an organic material, an inorganic material, or a combination thereof located on one surface or both, or opposite, surfaces of the porous substrate.

The porous substrate may be a polymer film formed of a polymer selected from polyolefins, such as polyethylene and polypropylene, polyesters, such as polyethylene terephthalate and polybutylene terephthalate, polyacetal, polyamide, polyimide, polycarbonate, polyether ketone, polyarylether ketone, polyetherimide, polyamideimide, polybenzimidazole, polyether sulfone, polyphenylene oxide, a cyclic olefin copolymer, polyphenylene sulfide, polyethylene naphthalate, glass fibers, and polytetrafluoroethylene (e.g., Teflon), or a copolymer or mixture of two or more thereof.

The organic material may include a polyvinylidene fluoride-based polymer or a (meth)acrylic-based polymer.

In an embodiment, the inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and the inorganic material may be present as a mixture in one coating layer, or present in a form in which a coating layer containing an organic material and a coating layer containing an inorganic material are stacked.

A first insulating plate 201 and a second insulating plate 202 may be respectively disposed at both, or opposite, sides of the electrode assembly 200. The first insulating plate 201 and the second insulating plate 202 may include an insulating material, such as rubber, polyethylene (PE), polypropylene (PP), polyethylene terephthalate (PET), or the like.

The first insulating plate 201 according to an embodiment may be formed to have a generally circular plate shape. The first insulating plate 201 may be disposed between an upper surface of the electrode assembly 200 and the cap assembly 300. Accordingly, the first insulating plate 201 may block the upper surface of the electrode assembly 200 from being in direct contact with the cap assembly 300, and insulate the electrode assembly 200 and the cap assembly 300 from each other. A through hole (not shown) through which the first electrode tab E1 may pass may be formed in the first insulating plate 201.

The second insulating plate 202 according to an embodiment may be formed to have a generally circular plate shape. The second insulating plate 202 may be disposed between a lower surface of the electrode assembly 200 and the bottom portion 120 of the case 100. Accordingly, the second insulating plate 202 may block the lower surface of the electrode assembly 200 from being in direct contact with the bottom portion 120 of the case 100 and insulate the electrode assembly 200 and the bottom portion 120 of the case 100 from each other. A through hole (not shown) through which the second electrode tab E2 may pass may be formed in the second insulating plate 202.

The cap assembly 300 may be coupled to the case 100 and may be disposed to face the electrode assembly 200. The cap assembly 300 may seal the case 100. For example, the cap assembly 300 may be disposed at an upper end portion of the side wall portion 110, that is, in the opening 130. The cap assembly 300 may be disposed to face the electrode assembly 200 along a direction parallel to the central axis C of the case 100.

The cap assembly 300 may be electrically connected to the first electrode 210 by the first electrode tab E1. In an embodiment, the first electrode 210 functions as the positive electrode of the electrode assembly 200, and the cap assembly 300 may function as the positive electrode terminal of the secondary battery.

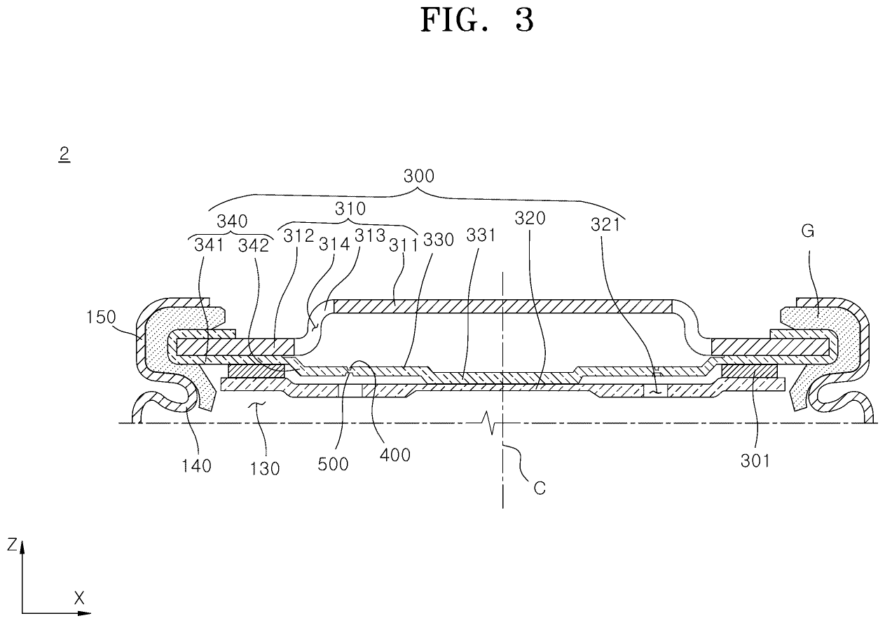

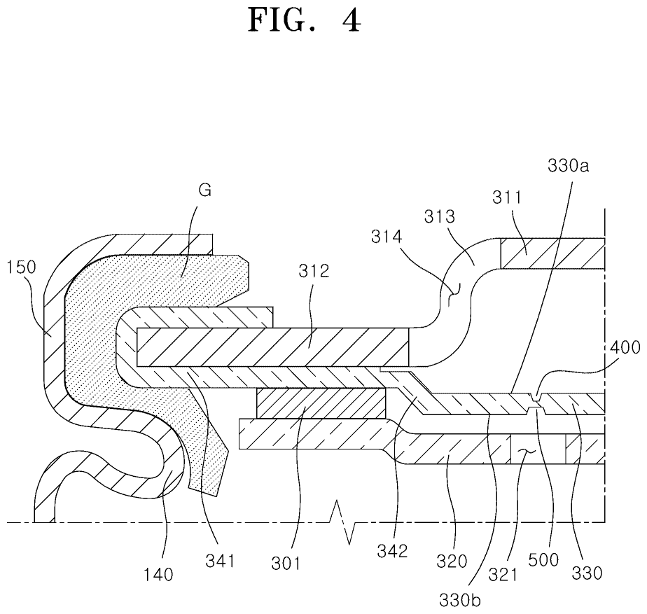

FIG. 3 is a view schematically illustrating a configuration of the cap assembly according to an embodiment of the present disclosure; and FIG. 4 is an enlarged view of a half region of the cap assembly of FIG. 3.

Referring to FIGS. 1 to 4, the cap assembly 300 according to an embodiment may include a cap up 310, a cap down 320, a vent plate 330, and an extending portion 340.

The cap up 310 may form an exterior of an upper side of the cap assembly 300. The cap up 310 may be electrically connected to the first electrode 210 by the cap down 320 and the vent plate 330 to be described below. In an embodiment, a central axis of the cap up 310 may be located coaxially with the central axis C of the case 100. A central portion of the cap up 310 may protrude outward from the case 100. The cap up 310 may include an electrically conductive material, such as nickel, aluminum, copper, or the like.

The cap up 310 according to an embodiment may include a small diameter portion 311, a large diameter portion 312, and a bridge 313.

In an embodiment, the small diameter portion 311 and the large diameter portion 312 may have circular plate shapes having different diameters. The diameter of the small diameter portion 311 may be smaller than the diameter of the large diameter portion 312. In an embodiment, central axes of the small diameter portion 311 and the large diameter portion 312 may be disposed coaxially with the central axis C of the case 100. The small diameter portion 311 and the large diameter portion 312 may be disposed to face each other along the first direction. The small diameter portion 311 may be disposed at an upper side of the large diameter portion 312. The small diameter portion 311 may protrude outward from the case 100. The large diameter portion 312 may have a ring shape formed with a hollow in a center portion.

The bridge 313 may be disposed between the small diameter portion 311 and the large diameter portion 312. Both, or opposite, end portions of the bridge 313 may be respectively connected to an outer circumferential surface of the small diameter portion 311 and an outer circumferential surface of the large diameter portion 312. In an embodiment, the bridge 313 may have a curved surface shape extending to be curved from the small diameter portion 311 to the large diameter portion 312.

A cap up hole 314 for discharging gas or the like generated in the case 100 to the outside of the case 100 may be formed in the cap up 310. The cap up hole 314 according to an embodiment may have a hole shape passing through the bridge 313 of the cap up 310. A plurality of cap up holes 314 may be provided. The plurality of cap up holes 314 may be arranged at an interval (e.g., a certain interval) along a circumference of the central portion of the cap up 310.

The cap down 320 may be disposed to face the cap up 310 and may be electrically connected to the electrode assembly 200.

The cap down 320 according to an embodiment may be formed to have a generally circular plate shape. The cap down 320 may be disposed in the case 100. The cap down 320 may be disposed at a lower side of the cap up 310. That is, the cap down 320 may be disposed between the cap up 310 and the electrode assembly 200. In an embodiment, the central axis of the cap down 320 may be disposed coaxially with the central axis C of the case 100. The upper surface of the cap down 320 may be disposed to be spaced apart from the lower surface of the cap up 310.

In an embodiment, an area of the cap down 320 may be smaller than a cross-sectional area of the electrode assembly 200 perpendicular to the central axis C of the case 100. However, the area of the cap down 320 is not limited thereto, and may be the same as the cross-sectional area of the electrode assembly 200 or may be greater than the cross-sectional area of the electrode assembly 200.

The cap down 320 may include an electrically conductive material, such as nickel, aluminum, copper, or the like. The cap down 320 may be electrically connected to the electrode assembly 200.

For example, the end portion of the first electrode tab E1 extending from the first electrode 210 may be connected to the lower surface of the cap down 320 by any of various types of coupling methods, such as welding and the like.

The cap down 320 may be electrically connected to the cap up 310 by the vent plate 330 to be described below.

A cap down hole 321 vertically passing through the cap down 320 may be formed in the cap down 320. The cap down hole 321 may provide a path through which gas or the like generated in the case 100 passes through the cap down 320 if an overcurrent occurs, for example. A plurality of cap down holes 321 may be provided. The plurality of cap down holes 321 may be arranged along a circumference centered on the central axis of the cap down 320.

The vent plate 330 may be disposed between the cap up 310 and the cap down 320. The vent plate 330 may provide an electrically conductive path of current between the cap up 310 and the cap down 320 when the secondary battery 2 normally operates. The vent plate 330 may include an electrically conductive material, such as nickel, aluminum, copper, or the like.

The vent plate 330 may be deformed by the pressure of gas generated in the case 100 and block an electrical connection between the cap up 310 and the cap down 320 if the overcurrent occurs. The vent plate 330 may be broken if the internal pressure of the case 100 rises above a certain magnitude (e.g., a set magnitude), and may open a discharge path for gas between the cap up hole 314 and the cap down hole 321.

The vent plate 330 according to an embodiment may be formed to have a generally circular plate shape.

The vent plate 330 may include a first vent surface 330a and a second vent surface 330b that are opposite to each other.

The first vent surface 330a and the second vent surface 330b according to an embodiment may be both, or opposite, surfaces of the vent plate 330 perpendicular to the central axis C of the case 100. The first vent surface 330a may be disposed to face the cap up 310, and the second vent surface 330b may be disposed to face the cap down 320.

The vent plate 330 may include a contact portion 331.

The contact portion 331 according to an embodiment may protrude from the vent plate 330 to the cap down 320 and may come into contact with the cap down 320. The contact portion 331 may electrically connect the vent plate 330 and the cap down 320. Accordingly, current generated from the first electrode 210 may be transmitted to the cap up 310 by sequentially passing through the first electrode tab E1, the cap down 320, the vent plate 330, and the extending portion 340.

The contact portion 331 may be disposed at a central portion of the vent plate 330. In an embodiment, a central axis of the contact portion 331 may be disposed coaxially with the central axis C of the case 100.

If the vent plate 330 is deformed due to an increase in internal pressure of the case 100, the contact portion 331 may be separated from the cap down 320. Accordingly, if an overcurrent occurs, the electrical connection between the cap down 320 and the vent plate 330 may be disconnected.

In an embodiment, a cap insulator 301 may be disposed between the vent plate 330 and the cap down 320. The cap insulator 301 may prevent or substantially prevent a remaining region of the vent plate 330 excluding the contact portion 331 from being in direct contact with the cap down 320. Accordingly, the cap insulator 301 may cause the vent plate 330 and the cap down 320 to be electrically connected only by the contact portion 331 to be described below.

In an embodiment, the cap insulator 301 according to an embodiment may be formed to have a hollow ring shape. In an embodiment, a central axis of the cap insulator 301 may be coaxially located with the central axis C of the case 100 and the central axis of the vent plate 330. An upper surface of the cap insulator 301 may be in contact with a lower surface of the vent plate 330, and a lower surface of the cap insulator 301 may be in contact with an upper surface of the cap down 320. The cap insulator 301 may be formed of an insulating material, such as polyethylene (PE), polypropylene (PP), polyethylene terephthalate (PET), or the like.

The extending portion 340 may extend from the vent plate 330 and may be connected to the cap up 310. The extending portion 340 may support the vent plate 330 with respect to the cap up 310 and provide an electrical connection between the cap up 310 and the vent plate 330. In an embodiment, the extending portion 340 may be formed of a same material as the vent plate 330. In an embodiment, the extending portion 340 may be formed integrally with the vent plate 330, or may be coupled to the vent plate 330 after being manufactured separately from the vent plate 330.

The extending portion 340 according to the embodiment may include a support portion 341 and a hinge portion 342.

The support portion 341 may form an exterior of a side of the extending portion 340 and may be connected to the cap up 310.

The support portion 341 according to an embodiment may be disposed to surround an end portion of the cap up 310 and, in an embodiment, an edge region of the large diameter portion 312. For example, the support portion 341 may have a generally U-shaped cross-sectional shape. An end portion of the support portion 341 may be in contact with the upper surface of the large diameter portion 312, and another end portion of the support portion 341 may be bent downward and may come into contact with a lower surface of the large diameter portion 312. The support portion 341 may be coupled the cap up 310 by any of various types of coupling methods, such as laser welding, ultrasonic welding, resistance welding, and the like.

The support portion 341 may be disposed to face the beading portion 140 along the first direction. For example, the support portion 341 may be disposed at an upper side of the beading portion 140. Accordingly, when the secondary battery 2 is assembled, the beading portion 140 may restrict the cap assembly 300 from being inserted into the case 100 beyond a certain distance (e.g., a set distance).

The hinge portion 342 may form an exterior of another side of the extending portion 340 and may be disposed between the support portion 341 and the vent plate 330. The hinge portion 342 may interconnect the support portion 341 and the vent plate 330 and induce deformation of the vent plate 330 if the internal pressure of the case 100 increases.

The hinge portion 342 according to an embodiment may have a generally circular ring shape and may be disposed between the support portion 341 and the vent plate 330. An inner circumferential surface of the hinge portion 342 may be connected to the vent plate 330, and an outer circumferential surface of the hinge portion 342 may be connected to the another end portion of the support portion 341. In an embodiment, the hinge portion 342 may extend downward in a stepwise manner from the outer circumferential surface to the inner circumferential surface. For example, the central portion of the hinge portion 342 may have a cross-section which is bent in an L shape.

If an overcurrent occurs, the vent plate 330 may be deformed based on the hinge portion 342. For example, if the internal pressure of the case 100 increases due to an overcurrent, the gas passing through the cap down hole 321 presses the vent plate 330 upward, and the vent plate 330 may be deformed in a form in which the central portion protrudes convexly upward due to a change in bending angle of the hinge portion 342.

The case 100 according to an embodiment may further include a crimping portion 150 which fixes a position of the cap assembly 300 and prevents or substantially prevents the cap assembly 300 from being separated from the case 100.

The crimping portion 150 according to an embodiment may extend from an upper end portion of the beading portion 140. An end portion of the crimping portion 150 may be bent toward the central axis C of the case 100. An inner side surface of the crimping portion 150 may be disposed to surround an outer circumferential surface of the support portion 341.

A gasket G may be disposed between the crimping portion 150 and the cap assembly 300. The gasket G may electrically insulate the case 100 and the cap assembly 300 from each other and prevent or substantially prevent moisture or an electrolyte from being introduced or discharged between the case 100 and the cap assembly 300.

The gasket G according to an embodiment may include an insulating material, such as rubber, polyethylene (PE), polypropylene (PP), polyethylene terephthalate (PET), or the like. The gasket G may be formed to have a generally ring shape. In an embodiment, the gasket G may have a generally U-shaped cross-section. An outer side surface of the gasket G may be in close contact with inner side surfaces of the crimping portion 150 and the beading portion 140. An inner side surface of the gasket G may be around (e.g., surround) an outer side surface of the support portion 341 and may be in close contact with the outer side surface of the support portion 341.

The first notch 400 may be formed concavely from the first vent surface 330a.

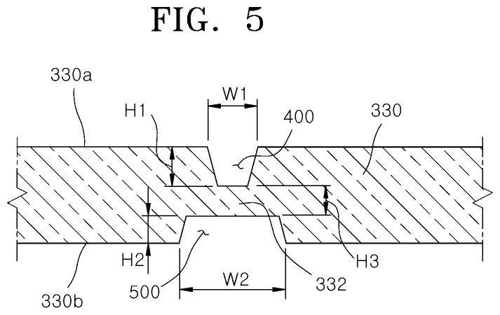

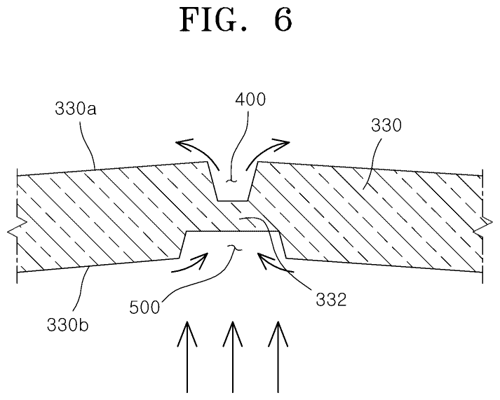

FIG. 5 is a view schematically illustrating configurations of the first notch and the second notch according to an embodiment of the present disclosure; and FIG. 6 is a view schematically illustrating a deformation operation of the vent plate according to an embodiment of the present disclosure.

The first notch 400 according to an embodiment may have a groove shape formed concavely from the first vent surface 330a toward the second vent surface 330b. In an embodiment, the first notch 400 may be formed to form a ring shape along an arc centered on the central axis C of the case 100.

A width of the first notch 400 may decrease toward the second vent surface 330b. For example, a cross-sectional shape of the first notch 400 may have a trapezoidal shape in which a width of an end portion facing the second vent surface 330b is narrower than a width of an end portion passing through the first vent surface 330a.

The second notch 500 may be formed concavely from the second vent surface 330b.

The second notch 500 according to an embodiment may have a groove shape formed concavely from the second vent surface 330b toward the first vent surface 330a. In an embodiment, the second notch 500 may be formed to form a ring shape along an arc centered on the central axis C of the case 100.

A width of the second notch 500 may decrease toward the first vent surface 330a. For example, the cross-sectional shape of the second notch 500 may have a trapezoidal shape in which a width of an end portion facing the first vent surface 330a is narrower than a width of an end portion passing through the second vent surface 330b.

The second notch 500 may be disposed to face the first notch 400. For example, a central line of the first notch 400 and a central line of the second notch 500 parallel to the central axis C of the case 100 may be disposed on a same straight line.

A bridge 332 may be formed between the first notch 400 and the second notch 500. The bridge 332 according to an embodiment may be a partial region of an entire region of the vent plate 330 disposed between the first notch 400 and the second notch 500. A thickness H3 of the bridge 332 may be formed to be relatively thinner than a thickness of the vent plate 330 by a depth H1 of the first notch 400 and a depth H2 of the second notch 500. Accordingly, the bridge 332 may be preferentially deformed and broken if the internal pressure of the case 100 increases and may induce a current blocking operation and a venting operation of the vent plate 330.

The secondary battery 2 according to an embodiment may relatively reduce the depth H1 of the first notch 400 while maintaining the thickness H3 of the bridge 332 the same as the first notch 400 and the second notch 500 disposed to face each other with the bridge 332 therebetween. Accordingly, a deformation angle of the bridge 332 may be relatively reduced under a same load condition compared to a case in which only the first notch 400 is formed in the vent plate 330, and cracks or fatigue destruction may be prevented or substantially prevented from occurring in the bridge 332 before the internal pressure of the case 100 reaches a breaking pressure.

The thickness H3 of the bridge 332 according to an embodiment may be greater than or equal to 0.04 mm and less than or equal to 0.1 mm.

If the thickness H3 of the bridge 332 is less than 0.04 mm, the breaking pressure of the bridge 332 may be excessively reduced, and the venting operation of the vent plate 330 may be performed unnecessarily by a small pressure change in the case 100.

If the thickness H3 of the bridge 332 is greater than 0.1 mm, the breaking pressure of the bridge 332 may be excessively increased, and the venting operation of the vent plate 330 may not be smoothly performed.

In an embodiment, the depth H2 of the second notch 500 may be greater than the depth H1 of the first notch 400. For example, the depth H1 of the first notch 400 may be 0.1 mm, and the depth H2 of the second notch 500 may be 0.1 mm to 0.16 mm.

At least a portion of a width of the second notch 500 may be greater than the width of the first notch 400.

In an embodiment, an entire width of the second notch 500 may be greater than the width of the first notch 400. That is, a minimum width of the second notch 500 may be greater than a maximum width W1 of the first notch 400. Here, the minimum width of the second notch 500 may mean a width of an end portion of the second notch 500 disposed to face the first vent surface 330a, and the maximum width W2 of the second notch 500 may mean a width of another end portion of the second notch 500 that is located on a same plane as the second vent surface 330b. Similarly, the minimum width of the first notch 400 may mean a width of an end portion of the first notch 400 disposed to face the second vent surface 330b, and the maximum width W1 of the first notch 400 may mean a width of another end portion of the first notch 400 located on a same plane as the first vent surface 330a. However, the present disclosure is not limited thereto, and the maximum width W1 of the first notch 400 may have a value between the minimum width and the maximum width W2 of the second notch 500.

In an embodiment, the second notch 500 may be formed by forging. That is, the second notch 500 may be formed concavely inward from the second vent surface 330b by pressing the second vent surface 330b facing the first notch 400 using a press device. Accordingly, the bridge 332 may have a relatively high density compared to the same thickness, and, thus, a deformation amount of the case 100 due to the internal pressure may be reduced.

Herein, an experimental example of the secondary battery according to an embodiment of the present disclosure will be described.

### Comparative Example 1

First, a vent plate 330 in which the first notch 400 was formed in the first vent surface 330a, and the second notch 500 was not formed in the second vent surface 330b was manufactured.

In Comparative Example 1, the bridge 332 refers to a partial region of the vent plate 330 disposed between the second vent surface 330b and the end portion of the first notch 400. In Comparative Example 1, the depth H1 of the first notch 400 was formed to be 0.23 mm and the thickness H3 of the bridge 332 was formed to be 0.07 mm.

### Example A

A vent plate 330 in which the first notch 400 was formed in the first vent surface 330a and the second notch 500 was formed in the second vent surface 330b was manufactured.

In Example A, the depth H1 of the first notch 400 was formed to be 0.1 mm, the depth H2 of the second notch 500 was formed to be 0.12 mm, and the thickness H3 of the bridge 332 was formed to be 0.08 mm.

### Example B

In Example B, a vent plate 330 in which the depth H2 of the second notch 500 was 0.14 mm and the thickness H3 of the bridge 332 was 0.06 mm was manufactured.

### Example C

In Example C, a vent plate 330 in which the depth H2 of the second notch 500 was 0.16 mm and the thickness H3 of the bridge 332 was 0.04 mm was manufactured.

### Experimental Example

For the above Comparative Example 1, Example A, Example B, and Example C, a pressure of 10 kgf/cm² was repeatedly applied to the second vent surface 330b of the vent plate 330, and whether cracks occurred in the bridge 332 is shown in Table 1 below. The number of times the pressure was applied was set to 2400 times.

TABLE 1

| | | | | Whether |
|---|---|---|---|---|
| | H1 | H2 | H3 | cracks |
| | (mm) | (mm) | (mm) | occurred |
| Comparative | 0.23 | 0 | 0.07 | ◯ |
| Example 1 | | | | |
| Example A | 0.1 | 0.12 | 0.08 | X |
| Example B | 0.1 | 0.14 | 0.06 | X |
| Example C | 0.1 | 0.16 | 0.04 | X |

As a result of the experiment, it can be seen that cracks occurred in the bridge 332 in Comparative Example 1, but no cracks occurred in the bridge 332 in Example A. Further, it can be seen that no cracks occurred in the bridge 332 in Examples B and C in which thicknesses of the bridge 332 are less than that in Comparative Example 1. Accordingly, it can be seen that the cracks may be prevented from occurring in the bridge 332 due to reduction of the deformation amount of the bridge 332 when the second notch 500 is formed in the second vent surface 330b.

Herein, a secondary battery 2 according to another embodiment of the present disclosure will be described.

The secondary battery 2 according to an embodiment may be configured to differ from the secondary battery 2 according to the previously described embodiment of the present disclosure in terms of a configuration of the first notch 400.

Accordingly, in the description of the secondary battery 2 according to the present embodiment, the detailed configuration of the first notch 400 which is different from the secondary battery 2 according to the previously described embodiment of the present disclosure will be described.

For remaining configurations of the secondary battery 2 according to the present embodiment, the description of the secondary battery 2 according to the previously described embodiment of the present disclosure may be applied as is.

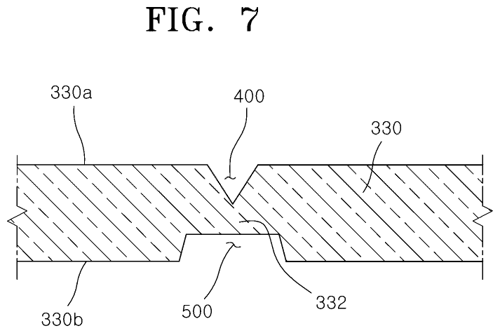

FIG. 7 is a view schematically illustrating configurations of the first notch and the second notch according to an embodiment of the present disclosure.

Referring to FIG. 7, a cross-section of the first notch 400 according to an embodiment may be formed to have a triangular shape in which a width of an end portion disposed to face the second vent surface 330b converges to a point.

Accordingly, the secondary battery 2 according to the present embodiment may induce a stress concentration phenomenon at an end portion of the first notch 400 such that the bridge 332 may be more quickly broken if an internal pressure of the case 100 rises above a pressure at which a venting operation of the vent plate 330 is performed.

Herein, a secondary battery 2 according to another embodiment of the present disclosure will be described.

The secondary battery 2 according to the present embodiment may be configured to differ from the secondary battery 2 according to the embodiment of FIG. 1 in terms of a configuration of the second notch 500.

Accordingly, in the description of the secondary battery 2 according to the present embodiment, the detailed configuration of the second notch 500 which is different from the secondary battery 2 according to the embodiment of FIG. 1 will be described.

For the remaining configurations of the secondary battery 2 according to the present embodiment, the description of the secondary battery 2 according to the embodiment of FIG. 1 may be applied as is.

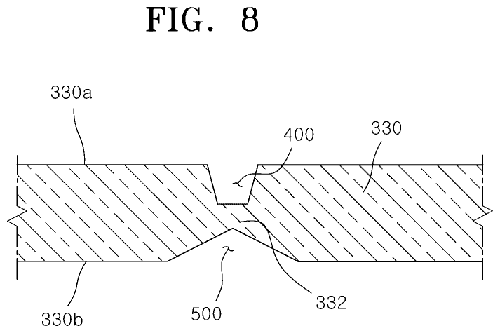

FIG. 8 is a view schematically illustrating configurations of the first notch and the second notch according to another embodiment of the present disclosure.

Referring to FIG. 8, a cross-section of the second notch 500 according to the present embodiment may be formed to have a triangular shape in which a width of an end portion disposed to face the first vent surface 330a converges to a point.

Accordingly, the secondary battery 2 according to the present embodiment may induce a stress concentration phenomenon at an end portion of the second notch 500 such that the bridge 332 may be more quickly broken if an internal pressure of the case 100 rises above a pressure at which a venting operation of the vent plate 330 is performed.

Herein, a secondary battery 2 according to another embodiment of the present disclosure will be described.

The secondary battery 2 according to the present embodiment may be configured to differ from the secondary battery 2 according to the embodiment of FIG. 1 in terms of detailed configurations of the first notch 400 and the second notch 500.

Accordingly, in the description of the secondary battery 2 according to the present embodiment, the detailed configurations of the first notch 400 and the second notch 500 which are different from the secondary battery 2 according to the embodiment of FIG. 1 will be described.

For the remaining configurations of the secondary battery 2 according to the present embodiment, the description of the secondary battery 2 according to the embodiment of FIG. 1 may be applied as is.

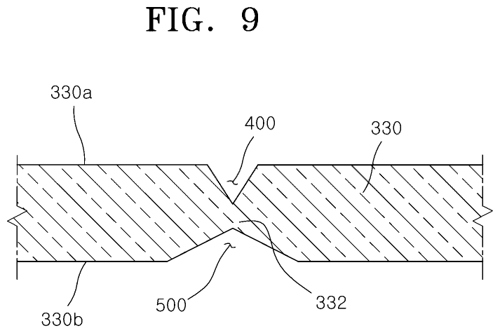

FIG. 9 is a view schematically illustrating the configurations of the first notch and the second notch according to another embodiment of the present disclosure.

Referring to FIG. 9, a cross-section of the first notch 400 according to the present embodiment may be formed to have a triangular shape in which a width of an end portion disposed to face the second vent surface 330b converges to a point, and a cross-section of the second notch 500 according to the present embodiment may be formed to have a triangular shape in which a width of an end portion disposed to face the first vent surface 330a converges to a point.

The cross-section of the first notch 400 according to the present embodiment may be formed to have a triangular shape in which a width of an end portion disposed to face the second vent surface 330b converges to a point, and the cross-section of the second notch 500 according to the present embodiment may be formed to have a triangular shape in which a width of an end portion disposed to face the first vent surface 330a converges to a point.

Accordingly, the secondary battery 2 according to the present embodiment may induce a stress concentration phenomenon at end portions of the first notch 400 and the second notch 500 such that the bridge 332 may be more quickly broken if an internal pressure of the case 100 rises above a pressure at which a venting operation of the vent plate 330 is performed.

Herein, a secondary battery 2 according to another embodiment of the present disclosure will be described.

The secondary battery 2 according to the present embodiment may further include an extending notch 501.

The secondary battery 2 according to the present embodiment may be configured to differ from the secondary battery 2 according to the embodiment of FIG. 1 by further including the extending notch 501.

Accordingly, in the description of the secondary battery 2 according to the present embodiment, the extending notch 501 that was not described in the secondary battery 2 according to the embodiment of FIG. 1 will be described.

For the remaining configurations of the secondary battery 2 according to the present embodiment, the description of the secondary battery 2 according to the embodiment of FIG. 1 may be applied as is.

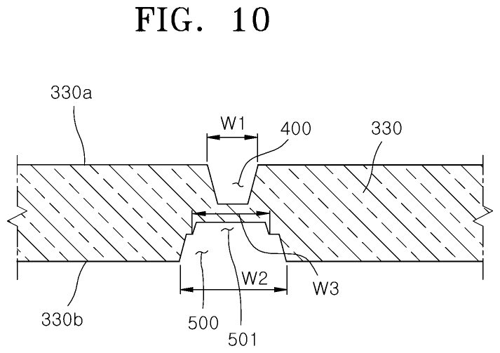

FIG. 10 is a view schematically illustrating a configuration of the extending notch according to another embodiment of the present disclosure.

Referring to FIG. 10, the extending notch 501 may be connected to the second notch 500.

The extending notch 501 according to the present embodiment may have a groove shape formed concavely from an end portion of the second notch 500 facing the first notch 400 toward the first vent surface 330a. In an embodiment, the extending notch 501 may be formed to form a ring shape along an arc centered on the central axis C of the case 100.

The extending notch 501 may be disposed to face the first notch 400. For example, a central line of the extending notch 501 and a central line of the first notch 400 parallel to the central axis C of the case 100 may be disposed on a same straight line. In an embodiment, the bridge 332 may be a partial region of the vent plate 330 disposed between the extending notch 501 and the first notch 400. Accordingly, the secondary battery 2 according to the present embodiment may further reduce a deformation amount of the bridge 332 if an internal pressure of the case 100 increases by further reducing a depth of the first notch 400.

A width of the extending notch 501 may decrease toward the first vent surface 330a. For example, a cross-sectional shape of the extending notch 501 may have a trapezoidal shape in which a width of an end portion facing the first vent surface 330a is narrower than a width of an end portion connected to the second notch 500.

At least a portion of the width of the extending notch 501 may be greater than a width of the first notch 400.

In an embodiment, an entire width of the extending notch 501 may be greater than the width of the first notch 400. That is, a minimum width of the extending notch 501 may be greater than a maximum width W1 of the first notch 400. Here, the minimum width of the extending notch 501 may mean a width of an end portion of the extending notch 501 disposed to face the first vent surface 330a, and the maximum width W3 of the extending notch 501 may mean a width of another end portion of the extending notch 501 located to be connected to the second notch 500. However, the present disclosure is not limited thereto, and the maximum width W1 of the first notch 400 may have a value between the minimum width and the maximum width W3 of the extending notch 501.

Herein, a secondary battery 2 according to another embodiment of the present disclosure will be described.

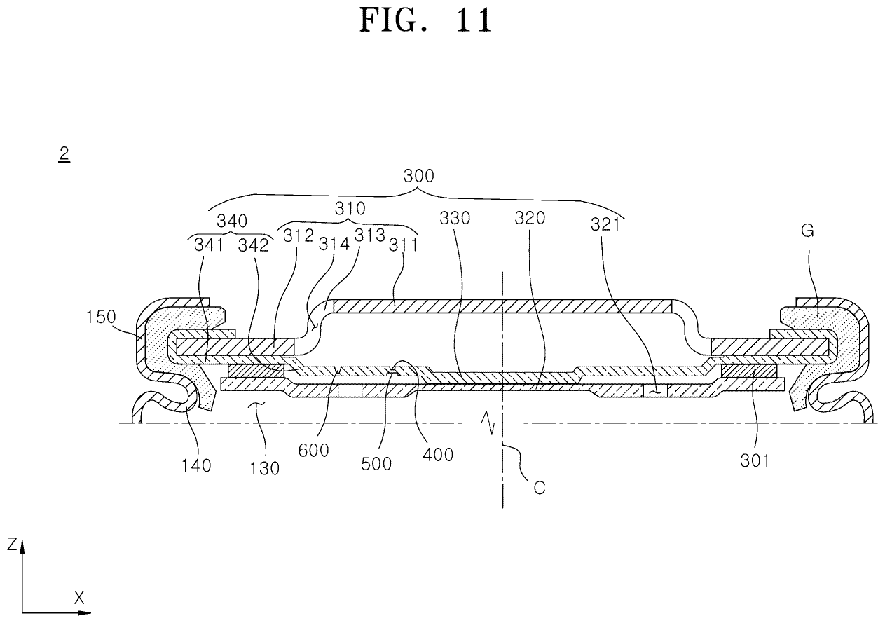

FIG. 11 is a view schematically illustrating a configuration of the secondary battery according to another embodiment of the present disclosure.

Referring to FIG. 11, the secondary battery 2 according to the present embodiment may further include a third notch 600.

The secondary battery 2 according to the present embodiment may be configured to differ from the secondary battery 2 according to the embodiment of FIG. 1 by further including the third notch 600.

Accordingly, in the description of the secondary battery 2 according to the present embodiment, the third notch 600 that was not described in the secondary battery 2 according to the embodiment of FIG. 1 will be described.

For the remaining configurations of the secondary battery 2 according to the present embodiment, the description of the secondary battery 2 according to the embodiment of FIG. 1 may be applied as is.

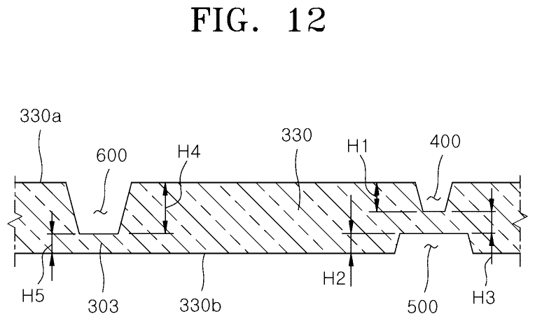

FIG. 12 is a view schematically illustrating a configuration of the third notch according to the present embodiment of the present disclosure.

Referring to FIGS. 11 and 12, the third notch 600 according to the present embodiment may have a groove shape formed concavely from the first vent surface 330a toward the second vent surface 330b. In an embodiment, the third notch 600 may be formed to form a ring shape along an arc centered on the central axis C of the case 100.

The third notch 600 may be disposed to be spaced apart from the first notch 400. For example, the third notch 600 and the first notch 400 may be spaced apart from each other by a certain interval along a radial direction centered on the central axis C of the case 100.

In an embodiment, a distance from the central axis C of the case 100 to the third notch 600 may be greater than a distance from the central axis C of the case 100 to the first notch 400. That is, the first notch 400 and the third notch 600 may be sequentially disposed from the central axis C of the case 100 along a radial direction of the vent plate 330.

In an embodiment, the third notch 600 and the second notch 500 may be disposed to be misaligned with each other. That is, a central line of the third notch 600 and a central line of the second notch 500 may be disposed on different straight lines parallel to each other.

An outer bridge 303 may be formed between the third notch 600 and the second vent surface 330b. The outer bridge 303 according to the present embodiment may refer to a portion of the vent plate 330 facing the third notch 600 among an entire region of the vent plate 330.

In an embodiment, a depth H4 of the third notch 600 may be greater than the depth H1 of the first notch 400. In an embodiment, a thickness H5 of the outer bridge 303 may be less than the thickness of the bridge 332. Accordingly, the third notch 600 may induce the outer bridge 303 to be broken before the bridge 332 if the internal pressure of the case 100 increases.

Herein, a battery pack including the secondary battery 2 will be described.

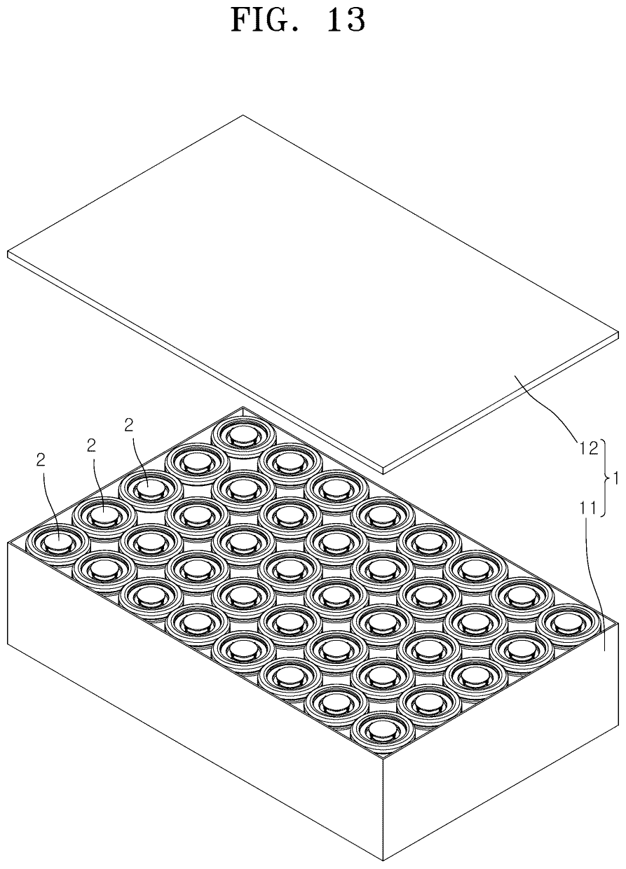

FIG. 13 is a perspective view schematically illustrating a configuration of a battery pack according to an embodiment of the present disclosure.

Referring to FIG. 13, the battery pack according to an embodiment may include a housing 1 and a secondary battery 2.

The housing 1 may generally form an exterior of the battery pack and provide a space where the secondary battery 2 may be accommodated.

The housing 1 according to an embodiment may include a housing body 11 and a cover 12.

The housing body 11 may be formed to have a box shape in which the inside is empty and a side is open. However, a cross-sectional shape of the housing body 11 is not limited to the quadrangular shape shown in FIG. 13, and may have any of various shapes, such as a polygonal shape, a circular shape, an oval shape, and the like.

The cover 12 may be coupled to the housing body 11 and close the inner space of the housing body 11. For example, the cover 12 may be formed to have a generally plate shape and may be disposed to face the open side of the housing body 11. The cover 12 may be fixed to the housing body 11 by any of various types of coupling methods, such as bolting, welding, fitting, and the like.

The secondary battery 2 may be disposed in the housing 1. The secondary battery 2 to be described below may be any one of the secondary batteries 2 according to the above-described embodiments.

A plurality of secondary batteries 2 may be provided. The plurality of secondary batteries 2 may be disposed to form any of various patterns, such as a grid shape, a zigzag shape, and the like in the housing 1. The plurality of secondary batteries 2 may be arranged parallel to each other. The number of secondary batteries 2 may be designed in various ways depending on the size, shape, and the like of the housing 1.

The plurality of secondary batteries 2 may be electrically connected by a bus bar (not shown). The plurality of secondary batteries 2 may be connected by the bus bar in series or parallel. For example, the bus bar may connect the secondary batteries 2 disposed in the same row in parallel with each other, and connect the secondary batteries 2 disposed in two adjacent rows in series with each other in the housing 1. The bus bar may be formed of an electrically conductive material, such as copper, aluminum, nickel, or the like.

According to embodiments of the present disclosure, different notches are formed on both, or opposite, surfaces of a vent plate, and if an internal pressure of a case increases, a deformation amount of a bridge can be relatively reduced and cracks in the bridge due to repeated input of a load less than a breaking pressure of the bridge can be prevented or substantially prevented from occurring.

However, aspects and effects obtainable through the present disclosure are not limited to the above aspects and effects, and other technical aspects and effects that are not mentioned will be clearly understood by those skilled in the art from the following description of the present disclosure.

While the present disclosure has been described with reference to some embodiments shown in the drawings, these embodiments are merely illustrative and it is to be understood that various modifications and equivalent other embodiments can be derived by those skilled in the art on the basis of the embodiments.

Therefore, the technical scope of the present disclosure should be defined by the claims.

What is claimed is:

1. A secondary battery comprising:
a case comprising an opening;
an electrode assembly in the case;
a cap up arranged in the opening;
a cap down facing the cap up and connected to the electrode assembly;
a vent plate between the cap up and the cap down and comprising a first vent surface and a second vent surface that are opposite to each other;
a first notch formed concavely from the first vent surface toward the second vent surface; and
a second notch formed concavely from the second vent surface toward the first vent surface.

2. The secondary battery as claimed in claim 1, wherein
the first vent surface faces the cap up, and
the second vent surface faces the cap down.

3. The secondary battery as claimed in claim 1, wherein the first notch and the second notch face each other.

4. The secondary battery as claimed in claim 3, wherein the second notch is forged.

5. The secondary battery as claimed in claim 3, wherein at least a portion of a width of the second notch is greater than a width of the first notch.

6. The secondary battery as claimed in claim 3, wherein a depth of the second notch is greater than a depth of the first notch.

7. The secondary battery as claimed in claim 3, wherein a width of the first notch decreases toward the second vent surface.

8. The secondary battery as claimed in claim 7, wherein a cross-sectional shape of the first notch is a trapezoidal shape.

9. The secondary battery as claimed in claim 7, wherein a cross-sectional shape of the first notch is a triangular shape.

10. The secondary battery as claimed in claim 3, wherein a width of the second notch decreases toward the first vent surface.

11. The secondary battery as claimed in claim 10, wherein a cross-sectional shape of the second notch is a trapezoidal shape.

12. The secondary battery as claimed in claim 10, wherein a cross-sectional shape of the second notch is a triangular shape.

13. The secondary battery as claimed in claim 3, wherein the vent plate comprises a bridge between the first notch and the second notch.

14. The secondary battery as claimed in claim 13, wherein a thickness of the bridge is greater than or equal to 0.04 mm and less than or equal to 0.1 mm.

15. The secondary battery as claimed in claim 1, further comprising an extending notch connected to the second notch and formed concavely toward the first vent surface.

16. The secondary battery as claimed in claim 15, wherein a width of the extending notch is smaller than a width of the second notch.

17. The secondary battery as claimed in claim 1, further comprising a third notch formed concavely from the first vent surface toward the second vent surface and spaced apart from the first notch.

18. The secondary battery as claimed in claim 17, wherein
the first notch and the second notch face each other, and
the third notch and the second notch are misaligned with each other.

19. The secondary battery as claimed in claim 17, wherein a depth of the third notch is greater than a depth of the first notch.

20. A battery pack comprising:
a housing; and
a plurality of secondary batteries accommodated in the housing,
wherein each of the secondary batteries comprises a case comprising an opening; an electrode assembly in the case; a cap up arranged in the opening; a cap down facing the cap up and connected to the electrode assembly; a vent plate between the cap up and the cap down and comprising a first vent surface and a second vent surface that are opposite to each other; a first notch formed concavely from the first vent surface toward the second vent surface; and a second notch formed concavely from the second vent surface toward the first vent surface.
